(19) United States
(12) Patent Application Publication
(10) Pub. No.: US 2016/0044096 A1
(43) Pub. Date: Feb. 11, 2016

(54) Scaling Up and Scaling Out of a Server Architecture for Large Scale Real-Time Applications

(71) Applicant: Microsoft Technology Licensing, LLC, Redmond, WA (US)

(72) Inventors: Sankaran Narayanan, Redmond, WA (US); Namendra Kumar, Redmond, WA (US); Krishnan Ananthanarayanan, Bothell, WA (US); Vijay Kishen Hampapur Parthasarathy, Sammamish, WA (US); Dhigha Sekaran, Redmond, WA (US); Vadim Eydelman, Bellevue, WA (US); Bimal K. Mehta, Sammamish, WA (US)

(73) Assignee: MICROSOFT TECHNOLOGY LICENSING, LLC, Redmond, WA (US)

(21) Appl. No.: 14/886,534

(22) Filed: Oct. 19, 2015

Related U.S. Application Data
(63) Continuation of application No. 13/676,436, filed on Nov. 14, 2012.

(51) Int. Cl. H04L 29/08; H04L 12/24

(52) U.S. Cl. CPC H04L 67/1004; H04L 41/0654

(57) ABSTRACT

Scaling up and scaling out of a server architecture for large scale real-time applications is provided. A group of users may be provisioned by assigning them to a server pool and allotting them to a group. Grouped users help to reduce inter-server communication when they are serviced by the same server in the pool. High availability may be provided by choosing a primary server and one or more secondary servers from the pool to ensure that grouped users are serviced by the same server. Operations taken on the primary server are synchronously replicated to secondary servers so that when a primary server fails, a secondary server may be chosen as the primary for the group. Servers for multiple user groups may be load balanced to account for changes in either the number of users or the number of servers in a pool. Multiple pools may be paired for disaster recovery.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many business organizations, large scale server applications are utilized by multiple user groups (e.g., a human resources group, an accounting group, etc.) for interacting among one another and for performing various functions. As changes in the number of users (or groups of users) using server applications in an organization occur, “scaling” may need to be implemented to accommodate the changes. One scaling approach is to add more power (i.e., processors machines and/or memory) to support a given entity (i.e., users or applications). This is known as “scaling up”. Another scaling approach is to add more machines (i.e., servers) to support a given entity (i.e., users or applications). This is known as “scaling out.” A third approach is a combination of the first two approaches (i.e., “scaling up” and “scaling out”). Current implementations of the aforementioned scaling approaches however, suffer from a number of drawbacks. For example, when scaling up such that all users in a system are equally likely to interact with one another, current implementations which distribute users evenly across all of an available number of servers will result in the amount of network traffic between servers to increase significantly and can cause an organization's computer system to choke in spite of an increased number of available machines. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for scaling up and scaling out of a server architecture for large scale real-time applications is provided. A group of users may be provisioned by assigning them to a server pool and allotting them to a group. Grouped users help to reduce inter-server communication when they are serviced by the same server in the pool. High availability may be provided by choosing a primary server and one or more secondary servers from the pool. In addition users belonging to the same group may be serviced by the same server. Operations taken on the primary server are synchronously replicated to secondary servers so that when a primary server fails, a secondary server may be chosen as the primary for the group. Servers for multiple user groups may be load balanced to account for changes in either the number of users or the number of servers in a pool. Multiple pools may be paired for disaster recovery. These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1A is a block diagram illustrating a server architecture for user group provisioning and load balancing functions which are associated with the scaling up and scaling out of the server architecture for large scale real-time applications, in accordance with an embodiment;

FIG. 1B is a block diagram illustrating a server architecture for providing a high server availability function which is associated with the scaling up and scaling out of the server architecture for large scale real-time applications, in accordance with an embodiment;

FIG. 2 is a block diagram illustrating the providing of a disaster recovery function which is associated with the scaling up and scaling out of the server architecture for large scale real-time applications, in accordance with an embodiment;

FIG. 3 is a flow diagram illustrating a routine for providing user group provisioning, load balancing, high server availability and disaster recovery functions in a server architecture for large scale real-time applications, in accordance with an embodiment; and

FIG. 4 is a simplified block diagram of a computing device with which various embodiments may be practiced.

### DETAILED DESCRIPTION

Scaling up and scaling out of a server architecture for large scale real-time applications is provided. A group of users may be provisioned by assigning them to a server pool and allotting them to a group. Grouped users help to reduce inter-server communication when they are serviced by the same server in the pool. High availability may be provided by choosing a primary server and one or more secondary servers from the pool. In addition users belonging to the same group may be serviced by the same server. Operations taken on the primary server are synchronously replicated to secondary servers so that when a primary server fails, a secondary server may be chosen as the primary for the group. Servers for multiple user groups may be load balanced to account for changes in either the number of users or the number of servers in a pool. Multiple pools may be paired for disaster recovery.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

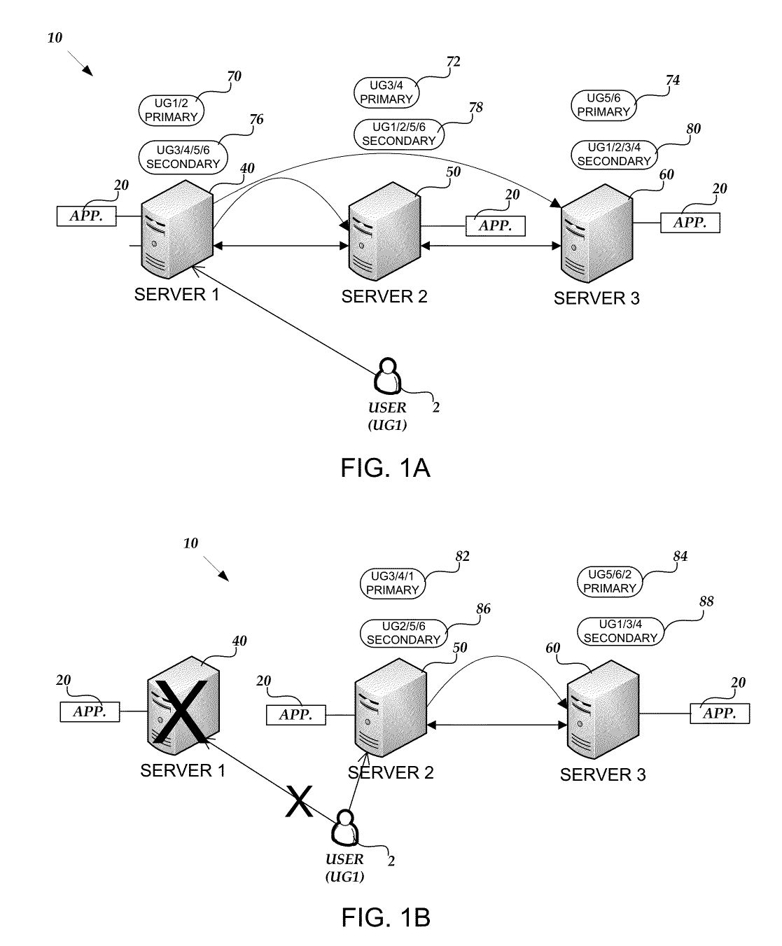

Referring now to the drawings, in which like numerals represent like elements through the several figures, various aspects of the present invention will be described. FIG. 1A is a block diagram illustrating a server architecture 10 which may be utilized for user group provisioning and load balancing functions which are associated with the scaling up and scaling out of the server architecture for large scale real-time applications, in accordance with an embodiment. When reading the following detailed description, the terms “machine,” “node,” “server” and “Front End” may be used interchangeably throughout and are synonymous. Similarly, the terms “pool” and cluster” may be used interchangeably throughout and are synonymous. As defined herein, a “pool” (or cluster) is a set of machines, nodes, servers or Front Ends.

The server architecture 10 includes servers 40, 50 and 60 which are in communication with each other. The set of the servers 40, 50 and 60 may collectively define a pool. Each of the servers 40, 50 and 60 may also function as both primary and secondary servers for different sets of tenant user groups. As defined herein a “tenant” may either be an organization or a sub-division of a large company. In accordance with the embodiments described herein, a pool may service multiple tenants (e.g., a single server pool may service multiple companies). In the server architecture 10, the server 40 may serve as a primary server for group 70 (which includes tenant user groups (UG) 1 and 2) and as a secondary server for group 76 (which includes tenant user groups (UG) 3, 4, 5 and 6). Similarly, the server 50 may serve as a primary server for group 72 (which includes tenant user groups (UG) 3 and 4) and as a secondary server for group 78 (which includes tenant user groups (UG) 1, 2, 5 and 6). Finally, the server 60 may serve as a primary server for group 74 (which includes tenant user groups (UG) 5 and 6) and as a secondary server for user group 80 (which includes tenant user groups (UG) 1, 2, 3 and 4). It should be understood that users in a user group have a static affinity to a pool. That is, when users are enabled for services in the server architecture 10, they are assigned to a server pool which would service them. A user (for example, the user 2) typically accesses applications and services from the primary server for the user's particular user group. For example, the user 2 in the server architecture 10 is part of UG 1 (i.e., tenant user group 1). Thus, the user 2 would typically access services and applications associated with UG 1 from the primary server 70.

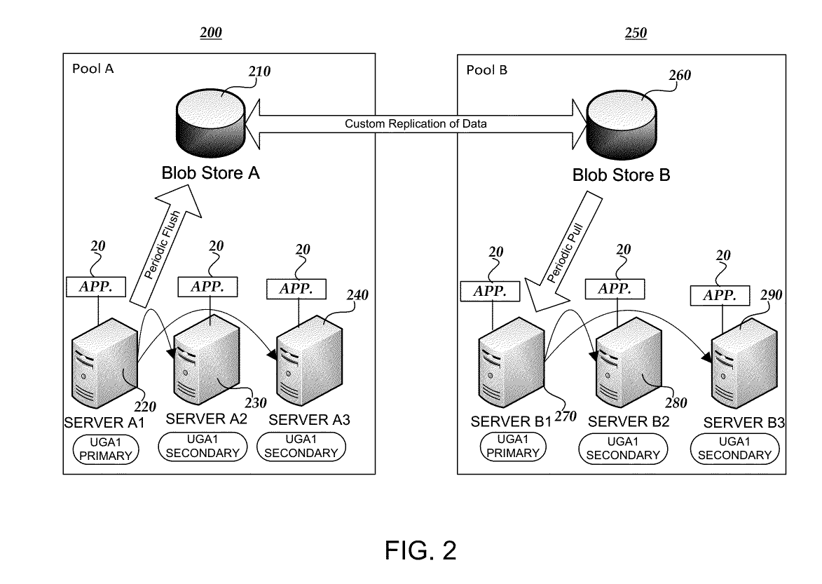

Each of the servers 40, 50 and 60 may also store an application 20 which may be utilized for providing user provisioning, high availability, load balancing (which will be discussed below) and disaster recovery (which will discussed with respect to FIG. 2) functions in the server architecture 10. In accordance with an embodiment, the application 20 may comprise the LYNC SERVER enterprise-ready unified communications platform software from MICROSOFT CORPORATION of Redmond, Wash. It should be understood, however, that other communications platform software from other manufacturers may alternatively be utilized in accordance with the various embodiments described herein.

For example, in providing user provisioning, the application 20 may be configured so that when users are assigned to a pool, they are also allotted to a group. It should be understood that, in accordance with an embodiment, grouping may be based on a number of constraints. These constraints may include: 1. Users of the same tenant should (but are not required to) be placed in the same group; and 2. The size of a group should not be greater than a pre-defined limit. It will be appreciated that by grouping users, the application 20 may facilitate a reduction of inter-server communication by having all of the users in a particular group serviced by the same machine.

In providing high availability, the application 20 may be configured to choose one primary server and one or more secondary servers (the number of secondary servers being based on the total number of servers in a pool and high availability guarantees granted) for each group of users. It should be understood that the higher the guarantee, the number of secondary servers which are chosen is increased. As discussed above, the aforementioned configuration allows all of the users in a particular group to be serviced by the same server. In providing high availability, it should be understood that any operation taken on a primary server is synchronously replicated (as shown by the curved arrows between the servers 40, 50 and 60) to the secondary servers. As a result, the loss of the primary server (e.g., due to failure) does not result in a loss of data. In particular, when a failure occurs on a primary server for a user group), one of the secondary servers may be chosen as the new primary for that user group. For example, FIG. 1B shows a failure having occurred at the server 40 which is designated as the primary server for user 2's tenant user group (i.e., UG1). In response, the server 50 is chosen by the application 20 to be the primary server for the user groups formerly served by the server 40. Thus, the server 50 now serves as the primary server for UG 1, UG 3 and UG 4 (i.e., the group 82) and as the secondary server for UG 2, UG 5 and UG 6 (i.e., the group 86). Similarly, the server 60 is also reconfigured (by the application 20) such that the server 60 now serves as the primary server for UG 2, UG 5 and UG 6 (i.e., the group 84) and as the secondary server for UG 1, UG 3 and UG 4 (i.e., the user group 88).

As discussed above, one server may serve as both a primary and/or secondary for multiple user groups. It should further be understood that one server may also be a primary for one group and a secondary for another group at the same time (i.e., simultaneously). However, a server may not be a primary as well as a secondary for the same group.

In providing a load balancing function for the server architecture 10, the application 20 may be configured to load balance servers by performing a calculation based on a ratio of a total number of tenant user groups and a total number of servers in a pool. For example, given N group of users and M number of servers, the load balancing function provided by the application 20 may attempt to make each server the primary server for N/M user groups. For example, as shown in FIG. 1B, there are two servers (servers 50 and 60) and six tenant user groups (UG 1, UG 2, UG 3, UG 4, UG 5 and UG 6) in the server architecture 10. Thus, in accordance with an embodiment, the application 20 may load balance the servers by designating one server as the primary server for three user groups (i.e., 6/2=3). It should be understood that in accordance with other embodiments, if the number of servers is changed by X, the load balancing function of the application 20 may attempt and make each server the primary for N/(M+X) user groups. It should be appreciated that X may be positive (i.e., when more machines are added to the pool) or negative (i.e., when one or more machines fails or is decommissioned). It should further be understood that secondary servers may be load balanced in the same manner (discussed above) as the primary servers. It should further be understood that in performing the load balancing function discussed above, the application 20 may choose one of the following approaches: 1. All of the servers may communicate with each other to determine a state of the pool and develop a load balancing strategy; and 2. All of the servers may communicate with a central authority which performs load balancing by keeping track of a state of the pool. It should be appreciated that utilizing the first approach eliminates a single point of failure for the pool.

FIG. 2 is a block diagram illustrating the providing of a disaster recovery function which is associated with the scaling up and scaling out of the server architecture for large scale real-time applications, in accordance with an embodiment. FIG. 2 shows two paired pools 200 and 250 (i.e., Pool A and Pool B). The pool 200 includes servers 220, 230 and 240 which serve as a primary server (i.e., the server 220) and secondary servers (i.e., the servers 230 and 240) for a tenant user group (i.e., UGA1). The pool 200 also includes a BLOB (“binary large object”) store 210. The pool 250 includes servers 270, 280 and 290 which also serve as a primary server (i.e., the server 270) and secondary servers (i.e., the servers 280 and 290) for the tenant user group UGA1). The pool 250 also includes a BLOB store 260. In both the pool 200 and the pool 250, each of the servers 220, 230, 240 and 270, 280, 290 may store the application 20 for providing disaster recovery functionality for the paired pools. It should be understood that the relationship between the pools 200 and 250 may be symmetric. It should further be understood that, in accordance with an embodiment, changes in data from the primary server 220 may be flushed to the BLOB store 210 by the application 20. The application 20 may further utilize a backup service (e.g., a custom sync agent) to synchronize data on the BLOB store 210 with the BLOB store 260 in the paired pool 250. The application 20 may further be utilized to periodically pull changes in data from the BLOB store 260 to the server 270 (which is the primary server for UGA1 in the pool 25) and replicate the changes to the secondary servers 280 and 290. It should be understood that that by periodically replicating changes occurring in the pool 200 to servers in the pool 250, the embodiments described herein ensure that when the pool 200 fails, most of the changes will already be available to the servers in the pool 250. As result, the servers in the pool 250 may start servicing users of the pool 200 very quickly. It should further be understood that the period of synchronization from server to BLOB store (and vice versa) may be determined by a data loss tolerance. In particular, the smaller the tolerance, the smaller the period of synchronization.

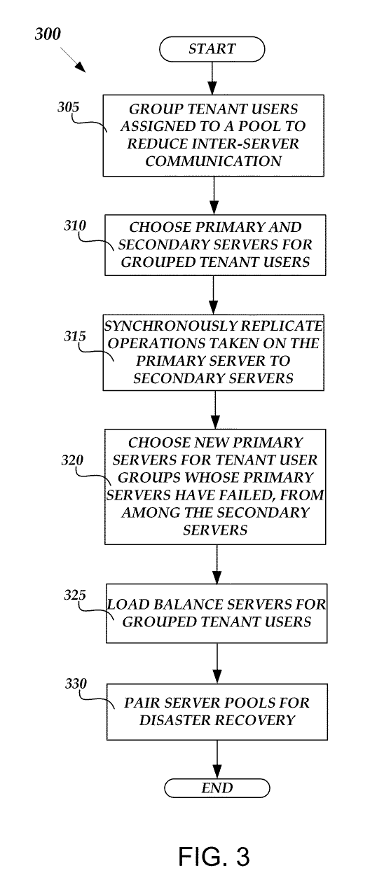

FIG. 3 is a flow diagram illustrating a routine 300 for providing user group provisioning, load balancing, high server availability and disaster recovery functions in a server architecture for large scale real-time applications, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 300 begins at operation 305, where the application 20 may be utilized to group tenant users assigned to a pool in a server architecture. It should be understood that by grouping the tenant users, the application 20 is utilized to reduce inter-server communication for the grouped tenant users because the tenant users are all being serviced by the same server in a pool.

From operation 305, the routine 300 continues to operation 310, where the application 20 may be utilized to choose a primary server and one or more secondary servers for each tenant user group. It should be understood that, in accordance with an embodiment, a single server may be simultaneously utilized as both a primary server and a secondary server for multiple tenant groups.

From operation 310, the routine 300 continues to operation 315, where the application 20 may be utilized to synchronously replicate operations taken on the primary server to one or more secondary servers.

From operation 315, the routine 300 continues to operation 320, where the application 20 may be utilized to choose new primary servers for the tenant user groups whose primary servers have failed, from among the secondary servers.

From operation 320, the routine 300 continues to operation 325, where the application 20 may be utilized to load balance the servers for the grouped tenant users. In particular, the application 20 may be configured to perform calculations for load balancing both the primary and secondary servers for each group of tenant users. The calculations may include taking a ratio of the number of tenant user groups and the number of servers in a pool.

From operation 325, the routine 300 continues to operation 330, where the application 20 may be utilized to pair server pools for disaster recovery. For example, when a majority of the servers in the pool 200 fail, the backup pool 250 will start servicing users of the pool 200. As described above with respect to FIG. 2, most of the data is already available to the servers of the backup pool 250. From operation 330, the routine 300 then ends.

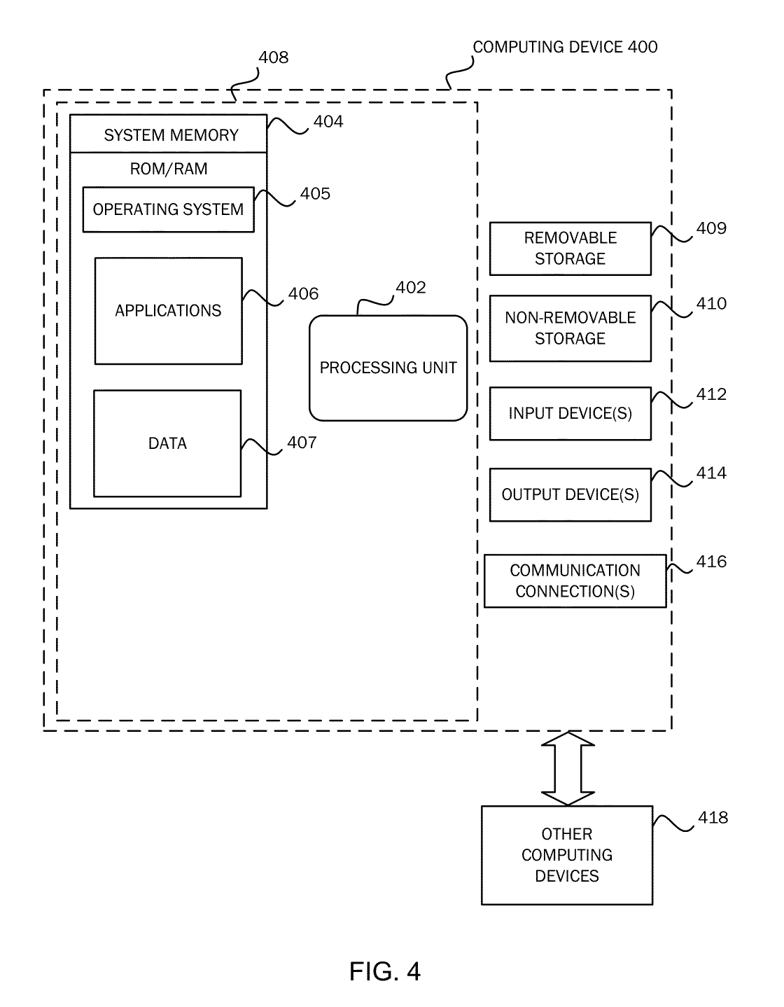

FIG. 4 is a block diagram illustrating example physical components of a computing device 400 with which various embodiments may be practiced. The computing device components described below may be suitable for the nodes 40, 50 and 60 described above with respect to FIGS. 1A, 1B and 2. In a basic configuration, the computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include an operating system 405, applications 406 and data 407. Operating system 405, for example, may be suitable for controlling computing device 400's operation and, in accordance with an embodiment, may comprise the WINDOWS operating systems from MICROSOFT CORPORATION of Redmond, Wash. The applications 406 may comprise the functionality of the application 20 described above with respect to FIGS. 1A, 1B, 2 and 3, described above. The applications 406 may also include other application programs. It should be understood that the embodiments described herein may also be practiced in conjunction with other operating systems and application programs and further, is not limited to any particular application or system.

The computing device 400 may have additional features or functionality. For example, the computing device 400 may also include additional data storage devices (removable and/or non-removable) such as, for example, magnetic disks, optical disks, solid state storage devices (“SSD”), flash memory or tape. Such additional storage is illustrated in FIG. 4 by a removable storage 409 and a non-removable storage 410.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 400 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 400. Any such computer storage media may be part of the computing device 400. The computing device 400 may also have input device(s) 412 such as a keyboard, a mouse, a pen, a sound input device (e.g., a microphone), a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein. Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1.-20. (canceled)

21. A computer-implemented method of reducing inter-server communications among a plurality of servers in a server pool, the method comprising:
grouping a plurality of tenant users assigned to the server pool into a plurality of user groups based on affinity, wherein each user group of the plurality of user groups is limited to a pre-defined number of the tenant users that is less than a total number of the plurality of tenant users; and
assigning each of the plurality user groups to an assigned server selected from the plurality of servers in the server pool so that all of the tenant users in each user group of the plurality of user groups is serviced by a same server in the server pool.

22. The method of claim 21, further comprising:
assigning a secondary server from the plurality of servers to each user group of the plurality groups;
synchronously replicating operations taken on the assigned server to the secondary server assigned to each of the user groups.

23. The method of claim 22, wherein the plurality of user groups includes a first user group, the method further comprising:
determining that the assigned server for a first user group has failed, and
servicing all of the tenant users of the first user group for that assigned server with the assigned secondary server for the first user group based on the determination that the assigned server for the first user group fails.

24. The method of claim 22, wherein the plurality of user groups includes a first user group and a second user group, the method further comprising:
utilizing a single server of the plurality of servers as the assigned sever for the first user group and the secondary server for the second user group.

25. The method of claim 22, further comprising load balancing the plurality of servers by designating each of the plurality of servers as the assigned server for a calculated number of user groups.

26. The method of claim 25, wherein the calculated number of user groups is determined by a ratio of the plurality of user groups and the plurality of servers.

27. The method of claim 26, further comprises changing the ratio to account for at least one of:
an addition or a removal of one or more servers from the plurality of servers; or
an addition or a removal of one or more user groups from the plurality of user groups.

28. The method of claim 25, wherein load balancing the plurality of servers further comprises:
designating each of the plurality of servers as a secondary server for the calculated number of user groups.

29. The method of claim 25, wherein load balancing the plurality of servers further comprises:
determining whether to load balance the plurality of servers based on a current system state determined from communications between each of the plurality of servers.

30. The method of claim 21, further comprising pairing the server pool with another server pool for disaster recovery.

31. A system for reducing inter-server communications among a plurality of servers in a server pool, comprising:
a memory for storing executable program code; and
a processor, functionally coupled to the memory, the processor being responsive to computer-executable instructions contained in the program code and operative to:
divide a plurality of tenant users assigned to the server pool into at least a first user group and a second user group based on user affinity, wherein each of the first user group and the second user group is limited to a predefined number of the tenant users that is less than a total number of the plurality of tenant users;
assign the first user group to a first assigned server selected from the plurality of servers in the server pool;
service all of the tenant users in the first user group by the first assigned server;
assign the second user group to a second assigned server selected from the plurality of servers in the server pool; and
service all of the tenant users in the second user group by the second assigned server.

32. The system of claim 31, wherein the processor is further operative to:
assign the first user group to a first backup server selected from the plurality of servers in the server pool;
synchronously replicate operations taken on the first assigned server for the first user group to the first backup server;
assign the second user group to a second backup server selected from the plurality of servers in the server pool; and
synchronously replicate operations taken on the second assigned server for the second user group to the second backup server.

33. The system of claim 32, wherein the processor is further operative to:
determine a failure of the first assigned server; and
service all of the tenant users of the first user group by the first backup server based on the failure of the first assigned server.

34. The system of claim 32, wherein the processor is further operative to:
determine a failure of the second assigned server; and
service all of the tenant user of the second user group by the second backup server based on the failure of the first assigned server.

35. The system of claim 32, wherein a first assigned server is simultaneously utilized as the first assigned server for the first user group and as a backup server for a third user group of the plurality of user groups.

36. The system of claim 32, wherein the processor is further operative to load balance the plurality of servers by designating each server in the plurality of servers as a primary server for a calculated number of user groups.

37. The system of claim 36, wherein the calculated number of user groups is determined based on a ratio of the plurality of user groups and the plurality of servers.

38. The system of claim 37, wherein the processor is further operative to determine whether to load balance the plurality of servers based on a current system state determined from communications between each of the plurality of servers.

39. A computer storage medium not consisting of a propagated data comprising computer executable instructions which, when executed by a computer, will cause the computer to perform a method of reducing inter-server communications among a plurality of servers in a server pool, the method comprising:
dividing a plurality of tenant users assigned to the server pool into at least a first user group and a second user group based on user affinity, wherein each of the first user group and the second user group is limited to a predefined number of the tenant users that is less than a total number of the plurality of tenant users;
assigning the first user group to a first assigned server selected from the plurality of servers in the server pool;
assigning the first user group to a first backup server selected from the plurality of servers in the server pool;
synchronously replicating operations taken on the first assigned server for the first user group to the first backup server;
servicing all of the tenant users in the first user group by the first assigned server;
assigning the second user group to a second assigned server selected from the plurality of servers in the server pool;
servicing all of the tenant users in the second user group by the second assigned server;
assigning the second user group to a second backup server selected from the plurality of servers in the server pool;
synchronously replicating operations taken on the second assigned server for the second user group to the second backup server;
determining to load balance the plurality of servers based on a current system state determined from communications between each of the plurality of servers; and
pairing the server pool with another server pool for disaster recovery, wherein a relationship between the server pool and the another server pool is symmetric.

40. The computer storage medium of claim 39, wherein a first server is simultaneously utilized as the first assigned server for the first user group and as a backup server for a third user group from the plurality of tenant users.
